(19) United States
(12) Patent Application Publication
(10) Pub. No.: US 2019/0325560 A1
(43) Pub. Date: Oct. 24, 2019

(54) HIGH-RESOLUTION ANIMATED RASTER ARTWORK FOR DISPLAY

(71) Applicant: WRAPPED LLC, Venice, CA (US)

(72) Inventors: Ryland Arnoldi, Venice, CA (US); Samuel Seidman, Venice, CA (US)

(21) Appl. No.: 16/390,186

(22) Filed: Apr. 22, 2019

Related U.S. Application Data
(60) Provisional application No. 62/661,448, filed on Apr. 23, 2018.

(51) Int. Cl. G06T 3/40; G06T 11/60; H04N 1/00

(52) U.S. Cl. CPC G06T 3/4053; G06T 2210/36; H04N 1/00188; G06T 11/60

(57) ABSTRACT

Methods, systems, and devices for converting an original image into a high-resolution image. The method for creating the high-resolution image of the original artwork includes obtaining an overall size and an overall resolution. The method includes obtaining the original image. The original image has a size. The method includes determining a resolution of a layered file based on the overall size of the high-resolution image, the overall resolution of the high-resolution image and the size of the original image. The method includes capturing the original image into the layered file at the resolution. The method includes generating the high-resolution image using the layered file and outputting the generated high-resolution image.

### CROSS-REFERENCE TO RELATED APPLICATIONS

This application claims priority to and the benefit of U.S. Provisional Patent Application No. 62/661,448 titled “HIGH-RESOLUTION ANIMATED RASTER ARTWORK FOR DISPLAY,” filed on Apr. 23, 2018, and the entirety of which is hereby incorporated by reference herein.

### BACKGROUND

### 1. Field

This specification relates to a system, apparatus and method for creating high-resolution animated raster artwork for display on high resolution electronic screens, displays, projections or other devices.

### 2. Description of the Related Art

Digital image files utilize one of two different graphic formats: vector and raster. Vector graphics, which are the preferred format for files that are not photos, are made up of various points, lines or curves, which contain colors, gradients and other editable effects. Raster graphics or bitmap images, on the other hand, are the preferred format for photographs and are made up of pixels, which are squares of color. Currently, still images and videos created for large electronic screens over 6 feet by 8 feet use raster graphics, which fail to maintain image fidelity when displayed on large electronic screens, or computer generated vector files. Vector files may be scaled infinitely but this format fails to reproduce subtle textures and soft edges, such as those found or created in traditional oil or watercolor paintings.

Accordingly, there is a need for a system, apparatus and/or method that increases the size of original pieces of artwork, such as traditional oil and/or watercolor paintings for display on large electronic screens, high resolution displays, high resolution projections or other displays or devices without the loss of the subtle textures, soft edges, and/or other 4823-3208-0786.2 nuanced features of the original pieces of artwork to accurately reproduce the “look and feel” of the original pieces of artwork.

### SUMMARY

In general, one aspect of the subject matter described in this specification is embodied in a method that creates high-resolution content from digitally rasterized image files without the loss of visual detail present in the original artwork when displayed on a large electronic screen. The method for creating a high-resolution image of an original physical piece of artwork includes obtaining an overall size and an overall resolution of an image to be presented on the electronic screen. The method includes obtaining an original image that has a size. The method includes determining a resolution of a layered file based on the overall size of the image to be presented on the electronic screen, the overall resolution of the image to be presented on the electronic screen and the size of the original image. The method includes capturing the original image into the layered file at the determined resolution. The method includes generating the high-resolution image using the layered file and outputting the generated high-resolution image.

These and other embodiments may optionally include one or more of the following features. The high-resolution image may be a high-resolution large scale image or an image on a retina display. The method of generating the high-resolution large scale image using the layered file may include flattening the layered file into a single layer. The method of determining the resolution of the layered file may include calculating an amount of pixels in the high-resolution image based on the overall resolution and the overall size and calculating the resolution of the layered file such that the amount of pixels in the layered file is greater than or equal to the amount of pixels in the high-resolution image based on the size of the original image and the amount of pixels in the high-resolution image.

The method of capturing the original image may include scanning the original image at the resolution. The method of capturing the original image may include dividing the original image into multiple images, individually scanning each image and recomposing the multiple images into the layered file. The method of recomposing the multiple images may include determining a first portion of each image that overlaps with a second portion of another image, brushing the edges of the first and second portion, refining the edges, and recomposing the multiple images to form the layered file.

In another aspect, the subject matter is embodied in a computer-implemented method for creating a high-resolution large scale image of an original physical piece of artwork. The method includes obtaining an overall size and an overall resolution for the high-resolution large scale image. The method includes obtaining an image of the original physical piece of artwork having a size. The method includes capturing the image of the original physical piece of artwork into a layered file at a resolution based on the size of the original physical piece of artwork, the overall size for the high-resolution large scale image and the overall resolution for the high-resolution large scale image. The method includes forming the master image file by flattening the layered file into a single layer. The method includes generating the high-resolution large scale image using the master image file. The method includes outputting the generated high-resolution large scale image. The high-resolution large scale image has the same depth and richness as the original physical piece of artwork.

In another aspect, the subject matter is embodied in a digital imaging system. The digital imaging system includes a memory for storing an image of an original physical piece of artwork. The digital imaging system includes a display or a printer that displays or prints a generated high-resolution large scale image. The digital imaging system includes a processor that is configured to execute operations stored in the memory. The operations include obtaining an image of the original physical piece of artwork having a size. The operations include capturing the image into a layered file at a resolution based on the size of the original physical piece of artwork, the overall size for the high-resolution large scale image and the overall resolution for the high-resolution large scale image. The operations include forming the master image file by flattening the layered file into a single layer. The operations include generating the high-resolution large scale image using the master image file and rendering the high-resolution large scale image on the display or causing the printer to print the generated high-resolution large scale image. The high-resolution large scale imaging has the same depth and richness as the original physical piece of artwork.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale, and may be exaggerated to better illustrate the important features of the present invention.

FIG. 1 is a block diagram of an example digital imaging creation system according to an aspect of the invention.

FIG. 2 is a flow diagram of an example process for creating the high-resolution large scale image from the original artwork using the digital imaging creation system of FIG. 1 according to an aspect of the invention.

FIG. 3 shows an image of a high-resolution large scale graphic formed from multiple original artworks according to an aspect of the invention.

FIG. 4 shows images of multiple original artworks that form the high-resolution large scale image according to an aspect of the invention.

FIG. 5 shows multiple images with overlapping portions formed from the multiple original artworks according to an aspect of the invention.

FIG. 6 shows the overlapped portion that is brushed, refined and recomposed according to an aspect of the invention.

FIG. 7A shows an image of an original artwork scanned or captured to be processed with and without use of the digital imaging creation system of FIG. 1 according to an aspect of the invention.

FIG. 7B shows a high-resolution image of a portion of the original artwork that has been generated using the digital imaging creation system of FIG. 1 according to an aspect of the invention.

FIG. 7C shows a low-resolution image of a portion of the original artwork that has been generated by scaling the original artwork without use of the digital imaging creation system of FIG. 1 according to an aspect of the invention.

### DETAILED DESCRIPTION

Disclosed herein are systems, devices and methods to create large scale digital print files and animations from hand painted original artwork or other original images. A digital imaging system that uses the method to convert the original artwork into a high-resolution image allows for the high-resolution image to be displayed on large electronic displays, projections, screens, such as an electronic billboard, large screen television, movie screen, large scale light emitting diode (LED) display, plasma display, large scale liquid crystal display (LCD) or other output platforms, projections or displays for a large scale image (“large electronic screen”) having dimensions of 6 feet×8 feet or larger, for example. The digital imaging system may also display the high resolution image on a high resolution output device, such as a retina display, a virtual reality display or other high-resolution output devices, which have a high resolution, ultra-high resolution and/or high density of pixels. Hereinafter, these large electronic screens or high-resolution output devices may be referred to as an “electronic screen.” Unlike conventional methods, the method allows for the original artwork to be scaled and displayed on the electronic screen without losing the visual details of the original artwork. That is, the large scale graphic image maintains the look and feel of the original artwork. For example, the method reproduces the subtle textures, soft edges, and other nuanced features present in the original artwork on the electronic screen. By producing these high-resolution images on the electronic screen, while reproducing and/or maintaining the nuanced features of the original artwork, the higher quality presentation provides a more engaging experience for the observer and maintains the look and feel intended by the original artwork.

The method displays the high resolution images with more sharpness and clarity, smoother transitions and more fine-tuned gradients. This improves the user experience when viewing animation, artwork, shows or other images on the electronic screen, projection or other high resolution output display.

Other benefits and advantages include animating the large scale graphic to create time based moving image content with the subtle textures and soft edges of the original artwork. The digital imaging system may use the high-resolution images and interpret movement among the high-resolution images. By interpreting the movement and redrawing the high-resolution images for each frame of the animation, the image of the animation is smoother and has a higher resolution and fidelity than conventional methods.

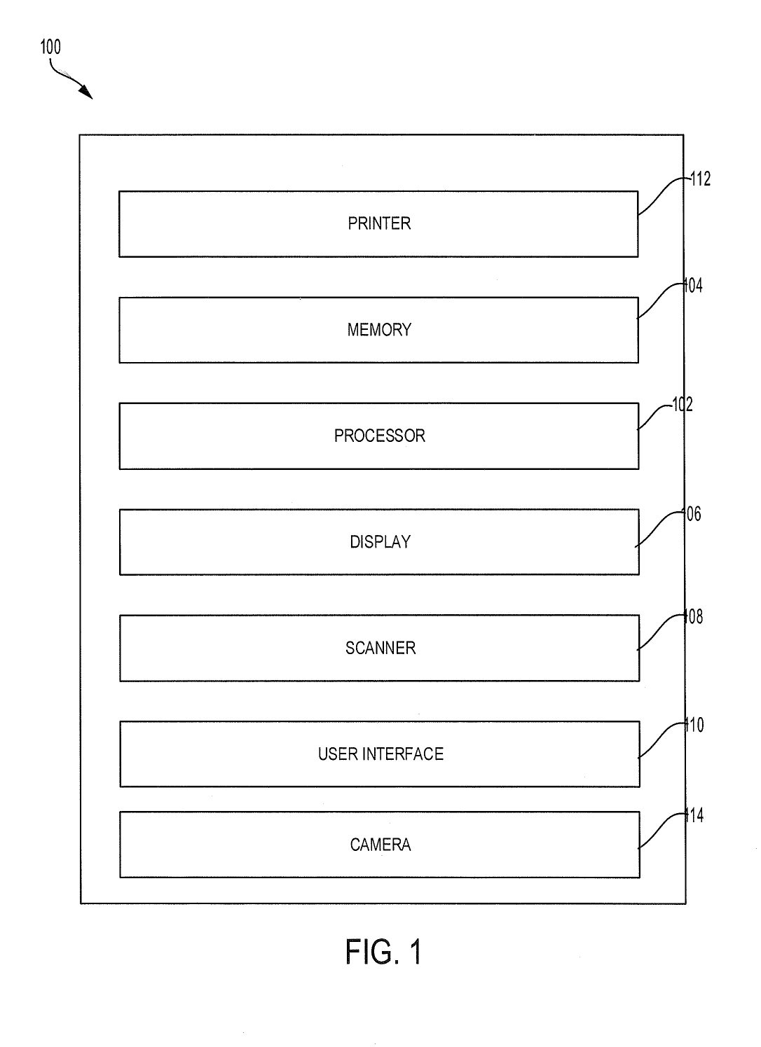

FIG. 1 is a block diagram of a digital imaging creation system 100 (“digital imaging system”) for creating a high-resolution large scale image from an original piece of artwork (“original artwork”). The original artwork may be a physical piece of artwork, such as a photograph, painting, a physical image of an object or other captured or scanned image of an object or a portion of an object, such as a grain pattern within a piece of wood or a fiber pattern within a piece of cloth or carpet. In one aspect of the invention, the digital imaging system 100 includes a processor 102, a memory 104, an output device, such as a display 106 or printer 112, a user interface 110, and other components that facilitate the digitization, alteration and/or output of the high-resolution large scale image. The digital imaging system 100 may include the output device or connect to the output device to output the high-resolution large scale image.

The digital imaging system 100 includes a processor 102. The processor 102 may include one or more data processing apparatuses, such as a controller or a computer. The processor 102 may access the memory 104 to perform programmed instructions stored on the memory 104. The processor 102 executes the programmed instructions to create the high-resolution large scale digital print files and/or animations from the original artwork. The processor 102 may perform functions, such as editing, erasure, recomposing, refining, blurring, masking or obscuring, on stored images to form the high-resolution large scale image. In another aspect, the processor 102 may perform other functions, such as the rendering of the high-resolution large scale image on an electronic screen or cause the printer to print or otherwise output the high-resolution large scale image.

The memory 104 may be coupled to the processor 102. The memory 104 may store instructions to execute on the processor 102 and may include a computer-readable medium, such as one or more of a RAM or other volatile or non-volatile memory. The memory 104 may be a non-transitory memory or a data storage device, such as a hard disk drive, a solid-state disk drive, a hybrid disk drive, or other appropriate data storage, and may further store machine-readable instructions, which may be loaded and executed by the processor 102. The memory 104 may store, for example, obtained scans of the original artwork that are further processed by the processor 102.

In one aspect, the digital imaging system 100 includes an output device, such as a display 106, a printer 112 or other output device that conveys an image. The display 106 may be an electronic screen. The processor 102 may render a high-resolution image or graphic on the display 106 to portray the original artwork, animation or other modified version of the original artwork. The printer 112 may be a physical device or an application on a device that prints or produces a physical copy, such as a paper copy, of original artwork or other modified version of the original artwork. In some implementations, the printer 112 produces a digital copy of the original artwork or other modified version of the original artwork, such as in an image or document file.

In one aspect, the digital imaging system includes a scanner 108, camera 114 or other image capture device or application that captures an image in a digital format. The scanner 108 may be a physical device or an application on a device that optically scans images, printed text, handwriting or an object. The scanner 108 converts the scanned images, printed text, handwriting or the object into a digital image. The camera 114 may be a physical imaging device or an application on a device that optically captures images, printed text, handwriting or an object in an image file.

The digital imaging system 100 includes a user interface 110 or other input/output device. The user interface 110 is a device capable of receiving user input, such as a keyboard, a touch screen, or a button. The user interface 110 may include a user interface element where the user may input information. The user interface 110 may be any device capable of output, such as a display and/or a speaker.

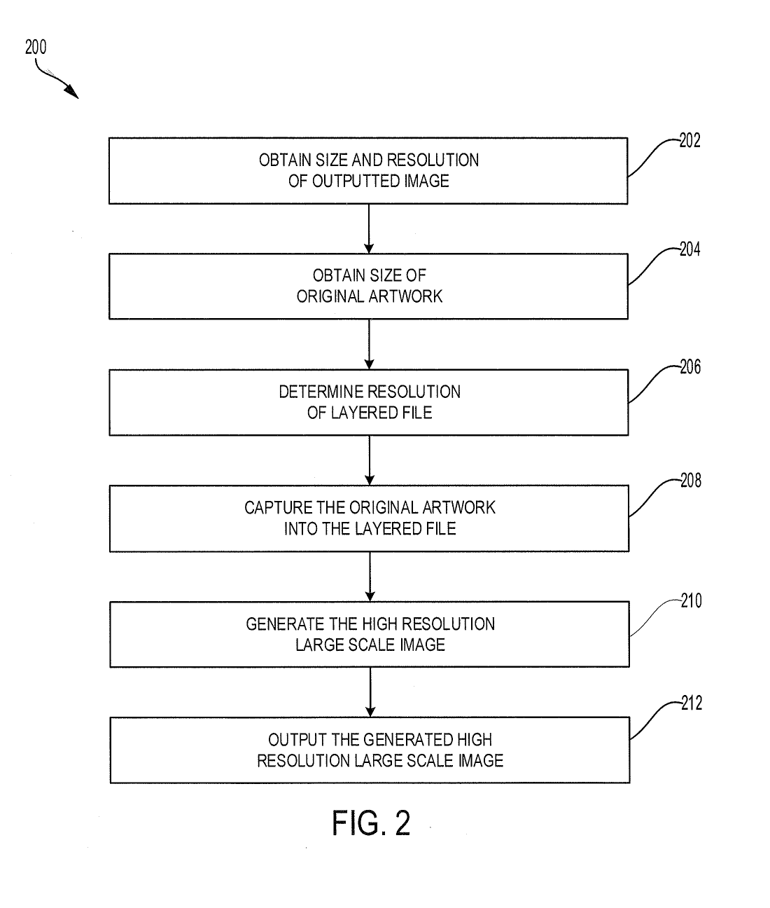

FIG. 2 describes the process 200 for creating the high-resolution large scale image from the original artwork. One or more computers or one or more data processing apparatuses, for example, the processor 102 of the digital imaging system 100 of FIG. 1, appropriately programmed, may implement the process 200.

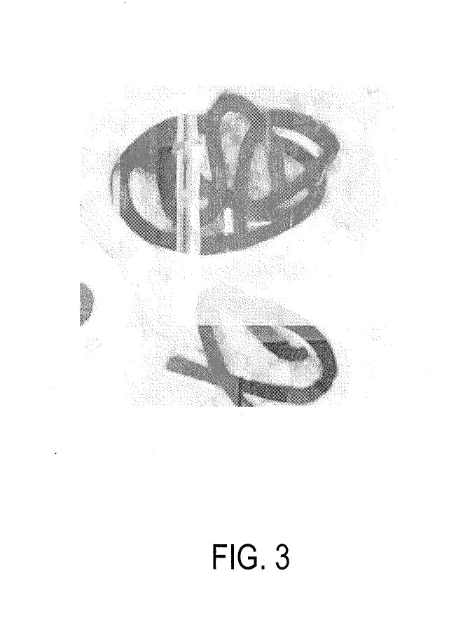

The digital imaging system 100 obtains a size and resolution of an outputted image, such as the high-resolution large scale image (202). In one aspect, the digital imaging system 100 may obtain the size and the resolution of the outputted image via user input from the user interface 110 or from the memory 104. For example, the outputted image may be displayed or projected on an electronic screen, retinal display or other high-resolution or large electronic screen. FIG. 3 shows an outputted image that may be developed by the digital imaging system 100 that has an overall size of 71″×71″, for example. In another aspect, the size and resolution may be pre-determined, stored in the memory 104, and retrieved from the memory 104 upon initialization of the digital imaging system 100. If the device upon which the outputted image is to be displayed or projected on is connected or part of the digital imaging system 100, the digital imaging system 100 may automatically detect the size and the resolution necessary.

The digital imaging system 100 obtains a size of the original artwork (204). In one aspect, the digital imaging system 100 may receive user input that indicates the size of the original artwork that is to be scaled and/or enlarged to form the outputted image that is displayed or printed at the larger scale. For example, the digital imaging system 100 may present an interface that requests the size of the original artwork and receive the user input, e.g., a voice/audio input or a keyboard input, from a user via an input device, such as a keyboard, mouse, touch screen or microphone. The size of the original artwork may be 5″×5″, for example. In another aspect, the digital imaging system 100 may automatically detect the size of the original artwork using a sensor, scanner, camera or other imaging device, for example.

The digital imaging system 100 may obtain the size of the original artwork when the digital imaging system 100 captures the original artwork using the scanner 108, camera 114 or another image capture device. The digital imaging system 100 may estimate or determine the size of the original artwork from the captured image. For example, the digital imaging system 100 may extract metadata, settings or other embedded data within the image file or image capture device settings that indicates the size of the original artwork. In another example, the digital imaging system 100 may determine the distance between the camera 114 and the artwork and the size of the image of the original artwork within the image file to determine the size of the original artwork.

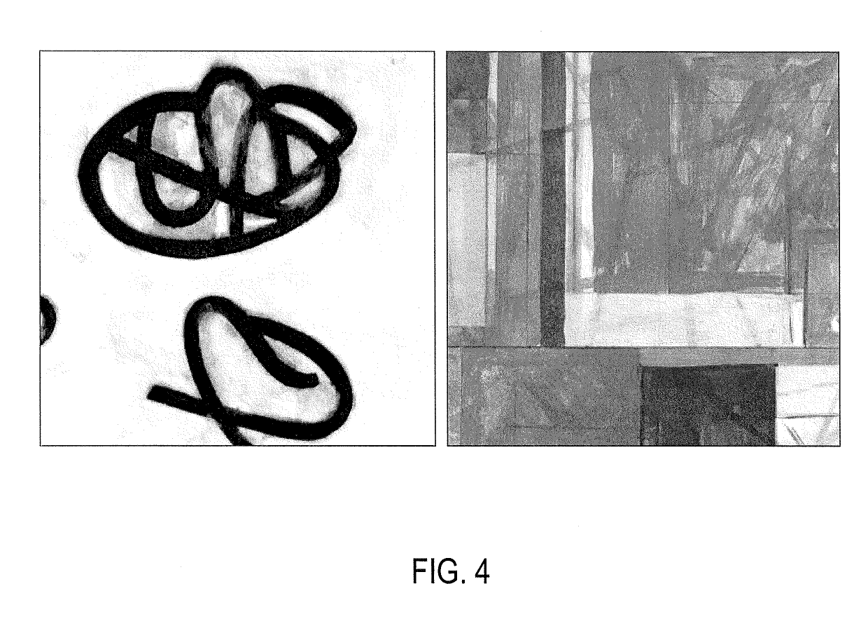

In some implementations, the digital imaging system 100 may obtain the size of multiple original artworks. The digital imaging system 100 may use the multiple original artworks to form the outputted image, and thus, the digital imaging system 100 obtains the size of each of the multiple original artworks, as shown in FIG. 4 for example.

The digital imaging system 100 determines a target resolution of a layered file (206). In one aspect, the digital imaging system 100 may calculate, identify or otherwise determine an amount of pixels in the outputted image based on the overall resolution and the overall size of the outputted image. For example, if the overall size of the outputted image is 71″×71″ and the outputted image is 300 dots per inch (dpi), the outputted image has a total pixel aspect ratio of approximately 21,300 pixels wide×21,300 pixels tall.

In one aspect, the digital imaging system 100 may calculate or otherwise determine the resolution of a layered file that later forms the outputted image based on the amount of pixels in the outputted image and the size of the original artwork. The resolution of the layered file results in an amount of pixels in the layered file that is greater than or equal to the amount of pixels in the outputted image. For example, if the outputted image has a total pixel aspect ratio of approximately 21,300 pixels wide×21,300 pixels tall, and the original artwork has a size of 5″×5″, the digital imaging system 100 may determine a target resolution for the layered file that is 4260 pixels per inch (ppi). The target resolution may be found by dividing the total pixel aspect ratio of the outputted image by the size of the original artwork. The digital imaging system 100 may use other approaches, such as using a mapping, logic tables or other relationship associations, and other features, such as pixel density, to determine or identify the target resolution of the layered file.

The digital imaging system 100 captures the original artwork into the layered file at the target resolution (208). In one aspect, the digital imaging system 100 may scan, capture or otherwise obtain an image of the original artwork, e.g., using the scanner 108 or the camera 114. The scanner 108 may scan the original artwork at a higher resolution, e.g., the target resolution, than the set industry standard, such as 300 dpi. In another aspect, the digital imaging system 100 may capture the original artwork using a camera or other image capturing device. In another aspect, the digital imaging system 100 may use a combination of image capturing devices to capture images of different portions of the original artwork and recompose the original artwork from the different portions captured in the different images.

Since the digital imaging system 100 may capture the original artwork at the higher resolution and is smaller than the outputted image, the digital imaging system 100 may scale the original artwork to the outputted image size and maintain the sharpness, the textures and the nuances of the original artwork. The scaling of the original artwork may have a margin of error as a result of an estimation or approximation of the scaling.

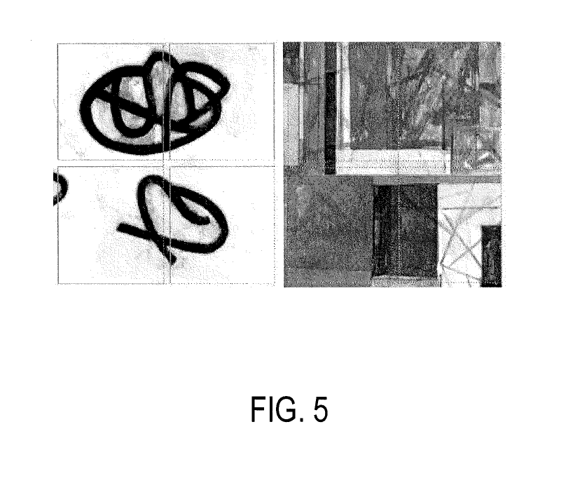

In some implementations, if the total pixel aspect ratio of the outputted image is greater than the pixel aspect ratio of the scanner 108, the digital imaging system 100 may divide the original artwork into multiple images and individually scan, capture or otherwise input each divided image. Each divided image may have overlap with one or more other divided images. For example, if the total aspect ratio is 21,300 px wide×21,300 px tall and the scanner 108 is limited to an aspect ratio of 30,000 px×21,000 px, the digital imaging system 100 may divide the original artwork into multiple images and scan each individually, e.g., 4 2.5″×2.5″ images at 4260 ppi when recomposed form the 21,300 px×21,300 px aspect ratio with each image having 10,650 pixels in total in either direction, as shown in FIG. 5 for example.

In some implementations, the digital imaging system 100 captures the original artwork at the same resolution as the outputted image. When the digital imaging system 100 captures the original artwork at the same resolution as the outputted, the digital imaging system 100 does not need to scale the original artwork to the outputted image size. Instead of approximating the scale from the original artwork to the outputted image, the digital imaging system 100 directly maps a pixel within the original artwork to a corresponding pixel, light-emitting diode or other unit of the display resolution of the outputted image.

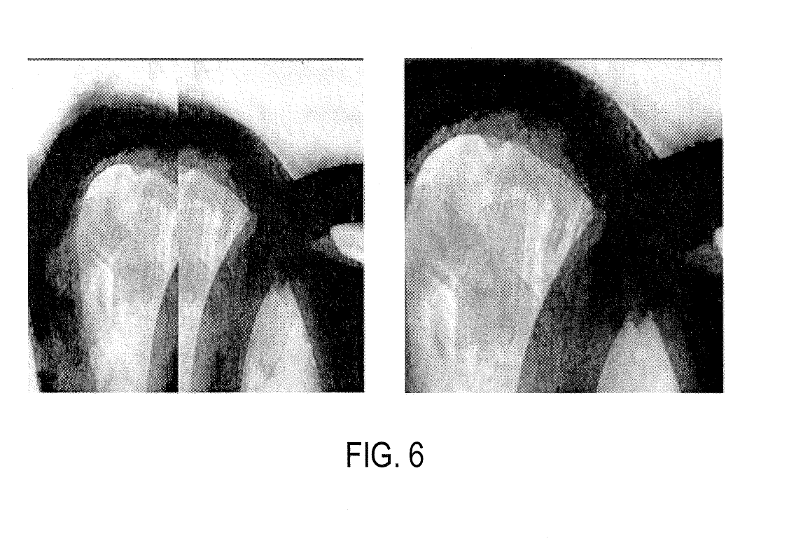

The digital imaging system 100 recomposes or otherwise reassembles the multiple images to form the layered file at the target resolution using the overlap between the multiple images. The digital imaging system 100 determines the portion of each image that overlaps with a portion of another image and places the multiple images into a grid. In one aspect, the digital imaging system 100 may brush, refine and recompose the edges of the overlapping portion to form the layered file, as shown in FIG. 6 for example. The digital imaging system 100 may perform other functions, such as obscuring edges of different opacities, to recompose the multiple images. Other functions to recompose the multiple images that the digital imaging system 100 may perform include masking and/or erasure to create the seamless edges of the recomposed images.

In order to perform the functions, such as erasure, brushing, masking, refining and recomposing the edges, in one aspect, the digital imaging system 100 may receive user input, e.g., from the user interface 110, that selects portions or areas to brush, refine, recompose or otherwise perform the function. In some implementations, the digital imaging system 100 may automatically determine the portions or areas to brush, refine, recompose or perform the function. By performing the functions on the overlapping portions, the digital imaging system 100 creates a more accurate digital representation without hard lines or other traces that may pose problems when enlarged.

The digital imaging system 100 may automatically erase, soften, blur, mask and/or adjust coloring and tonality to refine the edges of the layered file, which may be based on the contrast, sharpness and depth of areas within the overlapping portion. Other characteristics of the overlapping portions may be used to refine and soften the edges to form the layered file. For example, the digital imaging system 100 may measure the contrast, sharpness and/or depth of surrounding areas around an edge within the overlapping portion and select background pixels to be melded together, while sharpening foreground pixels. The digital imaging system 100 may compare the contrast, sharpness and/or depth of the pixels in an area to differentiate between background and foreground pixels. The digital imaging system 100 may meld the area around the edge across a larger area of the overlapped portion to create a seam. The size of area may depend upon the differences in contrast, sharpness and/or depth between the adjacent pixels. For example, a greater contrast results in a larger area that is required to obscure or mask the pixels to form the seam so that the edge appears cohesive.

In some implementations, the digital imaging system 100 receives user input to erase, soften, blur, mask and/or otherwise adjust the edges. Once the multiple images are composed or assembled together, the digital imaging system 100 forms the layered file that has the approximate dimensions of the original artwork. For example, the 4 2.5″×2.5″ images at 4260 ppi when recomposed form the 21,300 px×21,300 px aspect ratio with each image having 10,650 pixels in total in either direction. When multiple original works form the outputted image, the digital imaging system 100 may capture, divide, scan and recompose each of the original artworks.

In one aspect, the digital imaging system 100 generates or forms the high-resolution large scale image file from the layered file (210). To generate the high-resolution large scale image, the digital imaging system 100 flattens or compresses the layered file into a master image file. For example, if the layered file includes images from multiple original artworks, the digital imaging system 100 combines and flattens the images into a single layer to form a master image file that is used to generate the high-resolution large scale image file. The generated high-resolution large scale image file has the same or greater depth and richness of the original artwork and fills the physical dimensions of the outputted image regardless of any physical size discrepancy between different original artworks when there are multiple original artworks.

In some implementations, the digital imaging system 100 may use the generated high-resolution image file to create an animation. The digital imaging system 100 may obtain a length of time or number of frames for the animation and may draw multiple high-resolution image files that are each associated with different frames within the animation. The digital imaging system 100 interprets the movement among each high-resolution image file and redraws additional high-resolution images that incorporate the interpreted movement for the other frames within the animation. By interpreting the movement and redrawing the high-resolution images for each frame, the image of the animation is smoother and has a higher resolution and fidelity than when scaling and manipulation of the image is used. The high-resolution image file maintains or exceeds the pixel density of the original artwork.

In one aspect, the digital imaging system 100 may output the generated high-resolution image file onto an electronic screen or a large print, for example (212). The digital imaging system 100 may use a display 106 and render or project the high-resolution large scale image file onto the electronic screen or display 106. In some implementations, the digital imaging system 100 may output the generated high-resolution image file onto print using a printer 112. The digital imaging system 100 maintains substantially same pixel density for the high-resolution image file as the pixel density of the electronic screen to avoid the stretching of pixels where pixels are randomly filled and the discarding of pixels at random. In another aspect, the digital imaging system 100 may use another type of output device, such as a projector, to output the high-resolution image file to be viewed by an audience.

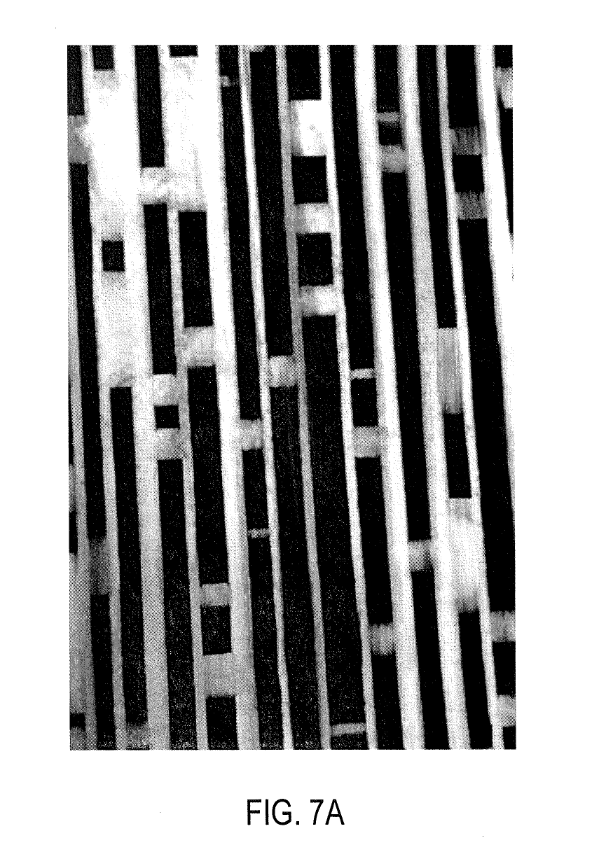

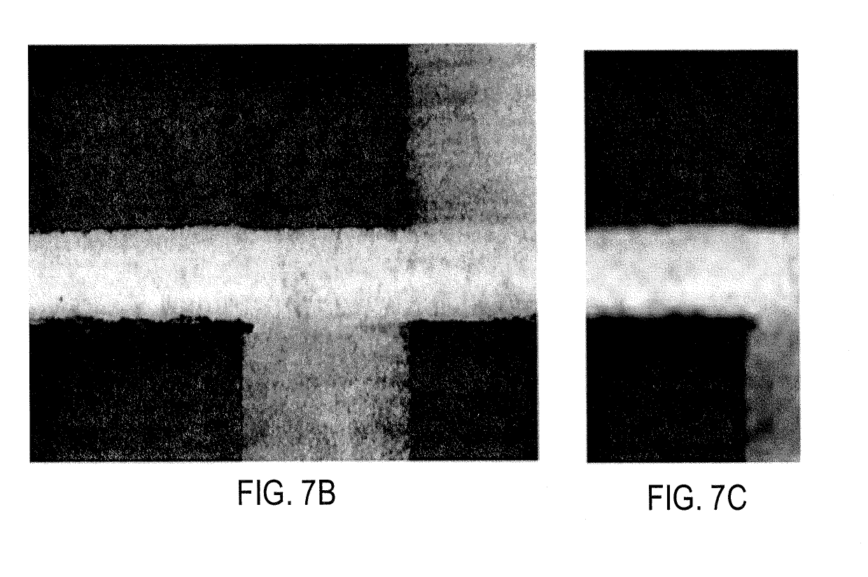

FIG. 7A shows an image of an original artwork scanned or captured to be processed using the digital imaging creation system 100, as shown in FIG. 7B for example, and to be scaled without use of the digital imaging creation system 100, as shown in FIG. 7C for example. FIG. 7B shows a close-up image of a portion of the original artwork that has been generated using the digital imaging creation system 100. FIG. 7C shows a close-up image of a portion the original artwork that has been scaled without use of the digital imaging creation system 100. As shown in FIG. 7B, the high-resolution image, which was generated using the digital imaging creation system 100 is much clearer, sharper and less pixelated than the low-resolution image, shown in FIG. 7C. For example, the edges of the different objects within the high-resolution image are much sharper, crisper and clearer in the high-resolution image generated by the digital imaging creation system 100 than the low-resolution image generated by scaling the original artwork without use of the digital imaging creation system 100.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A method for creating a high-resolution image, comprising
obtaining an overall size and an overall resolution of the high-resolution image;
obtaining an original image having a size;
determining a resolution of a layered file based on the overall size of the high-resolution image, the overall resolution of the high-resolution image and the size of the original image;
capturing the original image into the layered file at the resolution;
generating the high-resolution image using the layered file; and
outputting the generated high-resolution image, the generated high-resolution image having a same depth and richness as the original image.

2. The method of claim 1, wherein the high-resolution image is a high-resolution large scale image or an image on a retina display and generating the high-resolution large scale image using the layered file includes flattening the layered file into a single layer.

3. The method of claim 1, wherein determining the resolution of the layered file includes:
calculating an amount of pixels in the high-resolution image based on the overall resolution and the overall size; and
calculating the resolution of the layered file resulting in an amount of pixels in the layered file that is greater than or equal to the amount of pixels in the high-resolution image based on the size of the original image and the amount of pixels in the high-resolution image.

4. The method of claim 1, wherein capturing the original image includes scanning the original image at the resolution.

5. The method of claim 4, wherein capturing the original image includes:
dividing the original image into a plurality of images;
individually scanning each image of the plurality of images; and
recomposing the plurality of images into the layered file.

6. The method of claim 5, wherein recomposing the plurality of images into the layered file includes:
determining a first portion of each image of the plurality of images that overlaps with a second portion of another image of the plurality of images;
brushing edges of the first portion and edges of the second portion;
refining edges of each image of the plurality of images; and
recomposing the plurality of images to form the layered file.

7. A computer-implemented method for creating a high-resolution large scale image of an original physical piece of artwork, comprising
obtaining, by a processor, an overall size and an overall resolution for the high-resolution large scale image;
obtaining, by the processor and using an image capture device, an image of the original physical piece of artwork having a size;
capturing, by the processor and using the image capture device, the image of the original physical piece of artwork into a layered file at a resolution based on the size of the original physical piece of artwork, the overall size for the high-resolution large scale image and the overall resolution for the high-resolution large scale image;
forming, by the processor, a master image file by flattening the layered file into a single layer;
generating, by the processor, the high-resolution large scale image using the master image file; and
outputting, by the processor on a display or using a printer, the generated high-resolution large scale image, the high-resolution large scale image having a same depth and richness as the original physical piece of artwork.

8. The computer-implemented method of claim 7, further comprising:
determining the resolution of the layered file based on size of the original physical piece of artwork, the overall size for the high-resolution large scale image and the overall resolution for the high-resolution large scale image.

9. The computer-implemented method of claim 8, wherein determining the resolution of the layered file includes:
calculating an amount of pixels in the high-resolution large scale image based on the overall size and the overall resolution; and
calculating the resolution of the layered file resulting in an amount of pixels in the layered file that is greater than or equal to the amount of pixels in the high-resolution large scale image based on the size of the original physical piece of artwork and the amount of pixels in the high resolution image.

10. The computer-implemented method of claim 7, wherein capturing the image of the original physical piece of artwork includes at least one of scanning the original physical piece of artwork using a scanner or capturing the image of the original physical piece of artwork using a camera.

11. The computer-implemented method of claim 7, wherein capturing the image of the original physical piece of artwork includes:
dividing the original piece of artwork into a plurality of images;
individually scanning or capturing each image of the plurality of images; and
recomposing the plurality of images into the layered file.

12. The computer-implemented method of claim 11, wherein recomposing the plurality of images into the layered file includes:
determining a first portion of each image of the plurality of images that overlaps with a second portion of another image of the plurality of images;
brushing edges of the first portion and edges of the second portion; and
refining edges of each image of the plurality of images.

13. The computer-implemented method of claim 7, wherein the image capture device is at least one of a camera or scanner.

14. A digital imaging system, comprising:
a memory for storing an image of an original physical piece of artwork;
a display or a printer that displays or prints a generated high-resolution large scale image; and
a processor that is configured to execute operations stored in the memory, the processor performing operations comprising:
obtaining an image of the original physical piece of artwork having a size;
capturing the image of the original physical piece of artwork into a layered file at a resolution based on the size of the original physical piece of artwork, the overall size for the high-resolution large scale image and the overall resolution for the high-resolution large scale image;
forming the master image file by flattening the layered file into a single layer;
generating the high-resolution large scale image using the master image file, and
rendering the high-resolution large scale image on the display or causing the printer to print the high-resolution large scale image, the high-resolution large scale image having a same depth and richness as the original physical piece of artwork.

15. The digital imaging system of claim 14, further comprising:
an image capture device configured to capture the image of the original physical piece of artwork.

16. The digital imaging system of claim 15, wherein the image capture device is at least one of a scanner or a camera.

17. The digital imaging system of claim 16, wherein capturing the image of the original physical piece of artwork includes:
dividing the original piece of artwork into a plurality of images;
individually scanning or capturing each image of the plurality of images; and
recomposing the plurality of images into the layered file.

18. The digital imaging system of claim 17, wherein recomposing the plurality of images into the layered file includes:
determining a first portion of each image of the plurality of images that overlaps with a second portion of another image of the plurality of images;
brushing edges of the first portion and edges of the second portion including receiving user input that selects the first portion and the second portion to brush; and
refining edges of each image of the plurality of images.

19. The digital imaging system of claim 14, wherein the operations further comprise:
determining the resolution of the layered file based on size of the original physical piece of artwork, the overall size for the high-resolution large scale image and the overall resolution for the high-resolution large scale image.

20. The digital imaging system of claim 14, wherein the operations further comprise:
receiving user input that indicates the size of the original physical piece of artwork; or
determining or estimating the size of the original physical piece of artwork based on the captured image.
